(19) United States
(12) Patent Application Publication
(10) Pub. No.: US 2021/0370107 A1
(43) Pub. Date: Dec. 2, 2021

(54) MASK

(71) Applicant: SMOBIO Technology, Inc., Hsinchu City (TW)

(72) Inventor: KUAN-LIN LEE, Hsinchu City (TW)

(73) Assignee: SMOBIO Technology, Inc., Hsinchu City (TW)

(21) Appl. No.: 17/239,713

(22) Filed: Apr. 26, 2021

Related U.S. Application Data
(60) Provisional application No. 63/031,587, filed on May 29, 2020.

(51) Int. Cl. A62B 23/02; A41D 13/11

(52) U.S. Cl. CPC A62B 23/025; A41D 13/1115

(57) ABSTRACT

A mask comprising: a first layer in the shape of polygon includes an upper side, a bottom side and at least two short sides; a third layer in the shape of polygon includes an upper side and a bottom side and at least two short sides, and at least two short sides, the angle of bottom side of the third layer is the same as the angle of bottom of the first layer, the third layer is arranged parallel to the first layer, and at least one short side of the first layer is joined with the at least one short side of the third layer; and a second layer has an accordion-like folding structure, wherein the accordion-like folding structure is composed of alternate mountain-shaped folding lines and valley-shaped folding lines, wherein the first layer, the second layer and the third layer form a closed bag with an opening on the upper side, and when the opening is opened, accordion-like folding structure of the second layer is propped up and expanded inside the mask to form a space for the mouth and nose.

### CROSS-REFERENCE TO RELATED APPLICATIONS

The present application claims priority to U.S. provisional Appl. No. 63/031,587, filed May 29, 2020 which is incorporated herein by reference in its entirely.

### FIELD OF THE INVENTION

The present invention relates to a face mask. More specifically, the present invention is directed to convenience of carrying and provide sufficient internal space to make the user comfortable for protecting user and those around the wearer from a highly communicable airborne disease.

### BACKGROUND OF THE INVENTION

Masks, as a protective tool, have a certain filtering effect on the air entering the lungs. Whether in public places or hospitals, or in air-polluted environments, wearing masks to avoid respiratory diseases and other infectious diseases and preventing the spreading and avoiding the inhalation of excessive exhaust gas or dust have very good effects. With the improvement of filter cloth technology, the filtering effect of masks can now achieve a high protective effect. However, the higher the filtering effect often makes users be uncomfortable by increase the breathing resistance. In order to improve these discomforts, one method of the solution increasing the internal space of the mask. The current common cup masks are inconvenient to carry. Although the folding mask solves the problem of carrying, the existing folding structure is difficult to achieve the support of the mask and provide enough internal space. Therefore, how to balance the convenience of carrying and provide sufficient internal space to make the user comfortable when wearing is a problem that needs to be solved.

### DETAILED DESCRIPTION OF THE INVENTION

A mask comprising: a first layer in the shape of polygon includes an upper side, a bottom side and at least two short sides; A third layer in the shape of polygon includes an upper side and a bottom side and at least two short sides. The angle is formed by the bottom side of the first layer and any one of two short sides which is the same as the angle by the bottom side of the third layer and any one of two short sides. The first layer is arranged in parallel, and the at least one short side of the first layer is joined with the at least one short side of the third layer; and A second layer has an accordion-like folding structure, wherein the accordion-like folding structure is composed of alternate mountain-shaped folding lines and valley-shaped folding lines, the mountain-shaped folding lines and the valley-shaped folding lines are parallel to the upper side and the bottom side of the first layer and the upper side and the bottom side of the third layer, the upper and bottom sides of the accordion-like structure are respectively joined to the bottom side of the first layer and the third layer, the left and right sides of the accordion-like folding structure are respectively sandwiched between at least two short sides of the first layer and the third layer, and the second layer is sandwiched between the first layer and the third layer when the mask is stored, and location of the second layer is close to the bottom of the first layer and the third layer, wherein the first layer, the second layer and the third layer form a closed bag with an opening on the upper side, and when the opening is opened, accordion-like folding structure of the second layer is propped up and expanded inside the mask to form a space for the mouth and nose. The upper side of the first layer is in contact with the base of the nose and the zygomatic part of the user and the upper side of the third layer is in contact with the user's jaw when wearing the mask.

In an embodiment, the accordion-like folding structure from top to bottom consists of 5, 7 or 9 folding lines which includes the bottom sides of the first layer and the third layer. In another embodiment, the accordion-like folding structure from top to bottom consists of 5 folding lines which includes the bottom sides of the first layer and the third layer.

In an embodiment, the interval width of adjacent the mountain line and the valley-shape folding line is 0.5 to 6 cm. In another embodiment, the interval width of adjacent is 2 cm.

In an embodiment, the angle is from 90° to 140°.

In another embodiment, the angle is from 100° to 130°.

In another embodiment, the angle is from 110° to 120°.

In a preferred embodiment, the bottom side of the first layer and the bottom side of the third layer and both of them form an angle with at least two short sides that is 115°.

In an embodiment, further comprising a first deformable material line, wherein the first deformable material line locates on the first layer and it is adjacent to the upper side of the first layer which configured to increase the fitness between the mask and the base of the nose and the zygomatic area of the user when wearing the mask.

In another embodiment, the mask further comprising a second deformable material line, wherein the second deformable material line locates on the third layer and it is adjacent to the upper side of the third layer which configured to increase the fitness between the mask and the user's jaw when wearing the mask.

In an embodiment, wherein the first layer, the third layer and the second layer are folded by the same piece of material.

In an embodiment, the mask further comprises at least one fixed strip engaged to two sides of the mask and configured to fix the mask when wearing the mask.

In an embodiment, the mask of the present invention, wherein the second layer further comprising plurality and adjacent triangle patterns between the mountain-shaped folding line and the valley-shaped folding line, each of them is opposite to each other.

In an embodiment, the mask of the present invention, wherein the any side of each of the triangle pattern is parallel to the mountain-shaped folding line or the valley-shaped folding line.

In another embodiment, the mask of the present invention, further comprising another triangle pattern on the first layer, the two sides of which correspond to the two sides of the bridge of the nose supplemented with the function of providing the mask support.

As used herein, the term “accordion-like folding structure” represents the second layer of the mask, which from top to bottom consists of 5, 7 or 9 folding lines which includes the bottom sides of the first layer and the third layer. These folding lines can be mountain-shaped folding line or valley-shaped folding line. The accordion-like structure consists of mountain-shaped folding lines and valley-shaped folding line, both of them appear repeatedly to form the accordion-like folding structure.

### BRIEF DESCRIPTION OF THE DRAWINGS

FIG. 1A is a side view of the mask of the present invention in an expanded state.

FIG. 1B is a side view of the mask of the present invention in an expanded state.

FIG. 2 is a top view of the mask of the present invention in the folded state.

FIG. 3 is a bottom view of the mask of the present invention in the folded state.

FIG. 4 is a front view of the mask of the present invention in the folded state.

FIG. 5 is a front view of the mask of the present invention in the expanded state.

FIG. 6 is a rear view of the mask of the present invention in the expanded state.

FIG. 7 is a perspective view of the second embodiment of the mask of the present invention.

FIG. 8 is a rear view of the second embodiment of the mask of the present invention in the expanded state.

FIG. 9 is a top view of the third embodiment of the mask of the present invention in the folded state.

FIG. 10 is a diagram of the fourth embodiment of the mask of the present invention.

### DETAILED DESCRIPTION OF A PREFERRED EMBODIMENT

The following example are not limiting the purposes, but it is used for presenting various aspects of the present invention.

First embodiment, taking an isosceles trapezoid as an example.

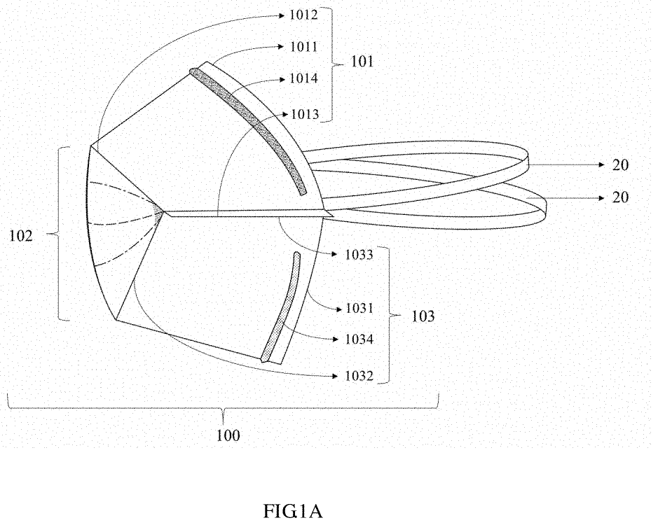

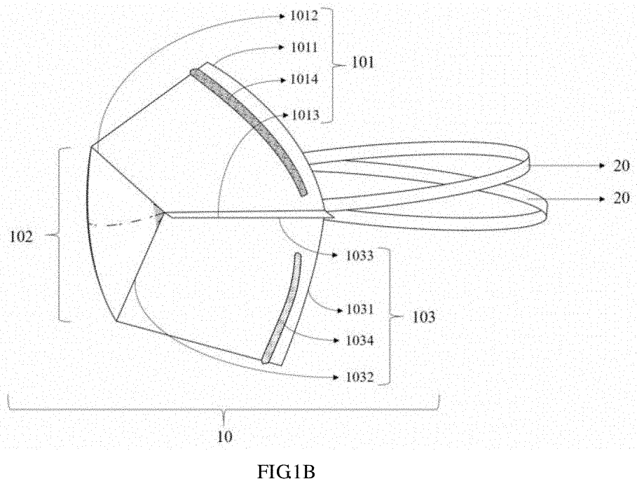

FIGS. 1A and 1B are side views that shows the structure of the mask (100) of the present invention, comprising: a first layer (101), in the shape of an isosceles ladder, with an upper side (1011) , a bottom side (1012) and two short sides (1013), wherein the upper side (1011) and the bottom side (1012) are parallel to each other; a third layer (103) is an isosceles trapezoid, It has an upper side (1031), a bottom side (1032) and two short sides (1033). The angle is formed by the bottom side of the first layer and any one of two short sides which is the same as the angle by the bottom side of the third layer and any one of two short sides. The third layer is parallel to the first layer, and the short side of the first layer (1013) is attached to the short side of the third layer (1033); and a second layer (102) have an accordion-like folding structure, wherein the accordion-like folding structure is composed of alternate the mountain-shaped folding line (shown as a dashed line in FIGS. 1A and 1B) and the valley-shaped folding line (shown as a chain-dotted line in FIGS. 1A and 1B) are composed of the mountain-shaped folding line and the valley-shaped folding line parallel to the upper side (1011, 1031) and the bottom side (1012, 1032), the accordion-like folding structure comprises the bottom side of the first layer (1012) and the bottom side of the third layer (1032) that totally contains 3, 5, 7, 9 folding lines from top to bottom, that can provide a better accommodating space for mouth and nose.

As shown in FIG. 1A, the accordion-like folding structure consists of 5 folding lines. As shown in FIG. 1B, the accordion-like folding structure is composed of 3 folding lines. The upper sides and the bottom sides of the accordion-like folding structure are respectively joined to the bottom side (1012) of the first layer (101) and the bottom side (1032) of the third layer (103). The left and right sides of the accordion-like folding structure are respectively sandwiched between the two short sides of the first layer (101) and the two short sides of the third layer (103), and the second layer (102) is sandwiched between the first layer (101) and the third layer (103) when stored between and near the bottom of the first layer (101) and the bottom of the third layer (103). The first layer (101), the second layer (102) and the third layer (103) of the mask form a upper side is a closed bag with an opening, and when the opening is opened, the accordion-like folding structure of the second layer (102) is propped up and expanded inside the mask to form an accommodating space for the mouth and nose to load. The upper side of the first layer (101) is in contact with the user's nose and zygomatic part and the upper side of the third layer (103) is in contact with the user's jaw while wearing the mask.

In order to increase the fitness between the mask and the base of the nose and the zygomatic region of the user during wearing, the mask of the present invention further comprises a deformable material line (1014) on the first layer (101). The deformable material line (1014) can be a deformable material such as metal or plastic, which is arranged on the upper side (1011) of the first layer (101) of the mask closely.

In addition, to increase the degree of adhesion between the mask and the chin of the user, the mask can also comprise a second deformable material line (1034) on the third layer (103), and the second deformable material line (1034) is arranged on third the upper side (1031) of third layer (103) of the mask. The mask of the present invention can be fixed to the user's face with at least one fixing belt body, which is arranged on the upper side of the mask and joined to the two sides of the mask so as to be fixed when the mask is worn. Using plurality of fixed straps (20) helps to enhance the stability of the mask for user when wearing. When preparing the mask of the present invention, the fitting, joining or clamping of the various elements can be achieved through known methods in the industry such as sewing, bonding or pressing.

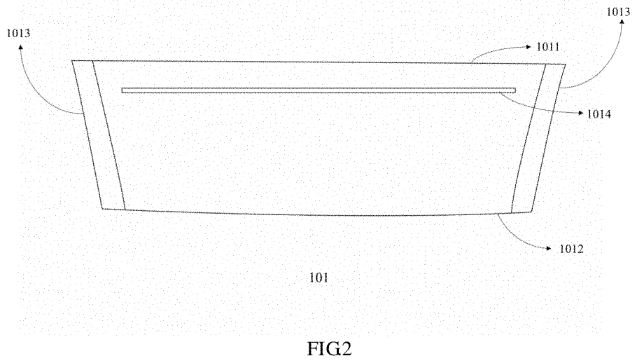

FIG. 2 is a top view of the mask of the present invention in a folded state, showing the first layer (101) of the mask of the present invention. The first layer (101) is an isosceles trapezoid in the folded state, with an upper side (1011), a bottom side (1012) and two short sides (1013), wherein the upper side (1011) and the bottom side (1012) are parallel to each other. The angle is formed by the isosceles trapezoidal bottom side (1012) of the first layer (101) and the two short sides (1013) of the first layer is from 90° to 140°. In an implementation example, the angle between the isosceles trapezoidal bottom side (1012) of the first layer (101) and the two short sides (1013) is 110°.

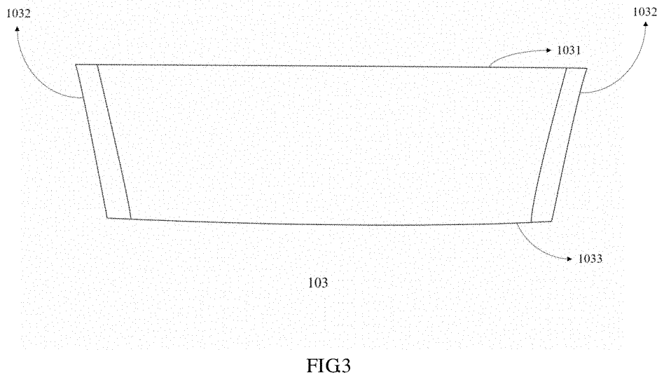

FIG. 3 is a bottom view of the mask of the present invention in the folded state, showing the third layer (103) of the mask of the present invention. The third layer is an isosceles trapezoid in the folded state, with an upper side (1031) and a bottom side (1032) and two short sides (1033). The angle is formed by the bottom side (1032) of the third layer (103) and the two short sides (1033) is from 90° and 140°. In an implementation example, the angle between the bottom side (1032) of the third layer (103) and the two short sides (1033) is 115°.

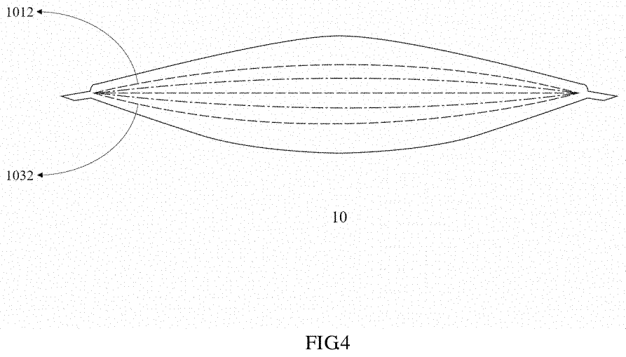

FIG. 4 is a front view of the mask of the present invention in the folded state, showing the second layer (102) of the mask of the present invention. The second layer (102) is an accordion-like folding structure, wherein the accordion-like folding structure is composed of alternate mountain-shaped folding lines (shown as dashed line in FIG. 4) and valley-shaped folding lines (shown as chain-dotted line in FIG. 4). The mountain-shaped folding line and the valley-shaped folding line are parallel to the upper sides (1011, 1031) and bottom sides (1012, 1032). The upper side and bottom side of the accordion-like folding structure are respectively joined to the bottom sides (1012, 1032) under the first layer (101) and the third layer (103).

Since the bottom sides (1012, 1032) of the first layer (101) and the third layer (103) are convex outward in this embodiment, they can also be the mountain-shaped folding lines for accordion-like folding structure in the second layer. Therefore, in this figure, the bottom sides (1012, 1032) under the first layer (101) and the third layer (103) are simultaneously marked with mountain-shaped folding lines and presented with dashed lines. The second layer of the accordion-like folding structure of the present invention is composed of an odd number of folding lines. The accordion-like folding structure comprises the bottom side (1012) of the first layer (101) and bottom side (1032) of the third layer (103) from top to bottom and that totally contains 3, 5, 7 or 9 folding lines which can provide a better mouth and nose accommodating space, 5 folding lines are the best in particular.

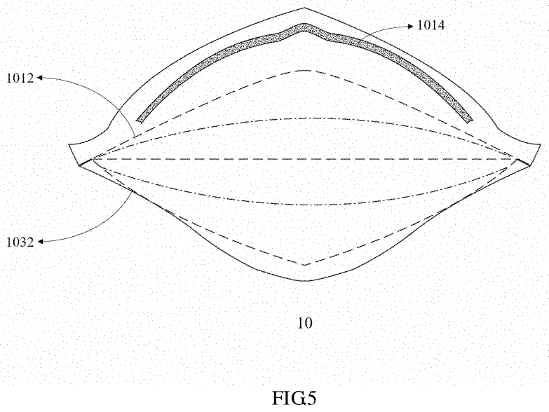

FIG. 5 is a front view of the mask of the present invention in the expanded state, showing the second layer (102) of the mask of the present invention. The second layer has an accordion-like folding structure, wherein the accordion-like folding structure is composed of alternate mountain-shaped folding lines (shown as dashed lines in FIG. 5) and valley-shaped folding lines (shown as dotted chain lines in FIG. 5). The adjacent mountain-shaped folding lines and valley-shaped folding lines of the accordion-like folding structure can be arranged at equal intervals or unequal distances, and the interval width of adjacent the mountain line and the valley-shape folding line is 0.5 to 6 cm. The mountain-shaped folding line and the valley-shaped folding line are parallel to the upper sides (1011, 1031) and bottom sides (1012, 1032) of the first layer (101) and the third layer (103). Above the accordion-like folding structure, the upper side and bottom side of which are respectively joined to the bottom sides (1012, 1032) of the first layer (101) and the third layer (103). The second layer of the accordion-like folding structure of the present invention is composed of an odd number of folding lines. The accordion-like folding structure comprises the bottom side (1012, 1032) of the first layer (101) and the third layer (103) from top to bottom and that totally contains 3, 5, 7 or 9 folding lines which can provide a better mouth and nose accommodating space, 5 folding lines are the best in particular.

As shown in FIG. 5, due to the bottom sides (1012, 1032) of the first layer (101) and the third layer (103) are convex outward in this embodiment, and it is marked with a mountain-shaped broken line and presented with a dashed line. At the same times, FIG. 5 shows the deformable material line (1014) is arranged on the first layer in the expanded state. It useful for the user to increase the fitness between the mask and the user's nose and zygomatic area when wearing.

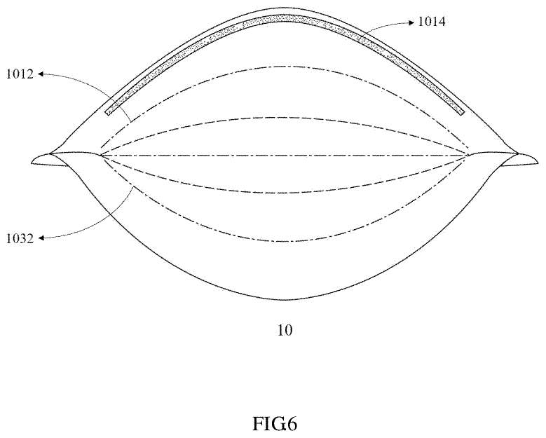

FIG. 6 is a rear view of the mask of the present invention in the expanded state, showing that the accordion-like folding structure of the second layer is propped up and expands inside the mask to form an accommodating space for users which is enough to include the nose and mouth. Since the bottom sides (1012, 1032) under the first layer (101) and the third layer (103) are convex outward in this embodiment. As shown in FIG. 6, the bottom sides (1012, 1032) of the first layer (101) and the third layer (103) are also marked with a valley-shaped folding line and presented as a chain-dotted line. FIG. 6 shows the deformable material line (1014) is arranged on the first layer after being stretched. It useful for the user to increase the fitness between the mask and the user's nose and zygomatic area when wearing.

In one embodiment, the first layer (101), the third layer (103) and the second layer (102) of the mask are formed by folding the same piece of sheet material. The mask of the present invention can be prepared by first folding out the accordion-like folding structure of the second layer (102), and then sandwiching the left and right sides of the accordion-like folding structure on the two short sides of the first layer (101) and the third layer (101). and is placed between the first layer (101) and the third layer (103), close to the bottom sides (1012, 1032) of the first layer (101) and the third layer (103) and pressed them together to get the bag body, and then cut off the unnecessary part of the bag body.

### Second Embodiment

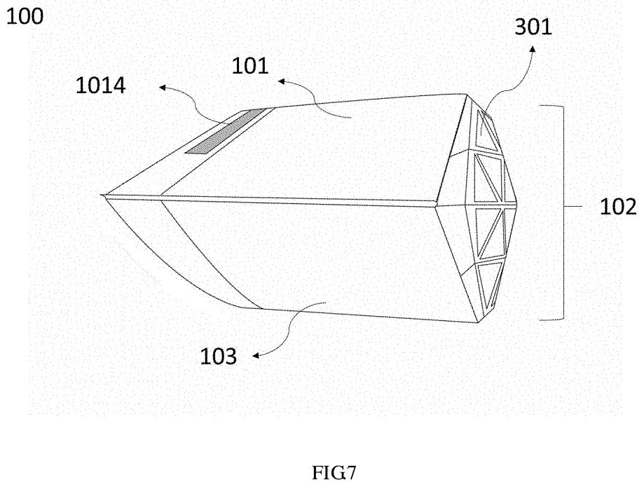

FIG. 7 is a perspective view of the second embodiment of the mask (100) of the present invention, which is the same as the mask of the first embodiment described above, having a first layer (101), a second layer (102) and a third layer (103), the difference is that the second layer (102) further comprising plurality and adjacent triangle patterns between the mountain-shaped folding line and the valley-shaped folding line. At the same time, due to the triangle patterns (301) of the second layer (102) are arranged adjacently and in opposite directions to each other.

Since any side of the triangular pattern (301) of the present invention will be close to and parallel to the mountain-shaped folding line or valley-shaped folding line, and the arrangement of which will make the accordion-like folding structure more stable and avoid the cloth or breathing space of the second layer (102) being collapsed during the exhalation/inhalation process, due to the moisture in the air, which gives the user better experience including breathing smoothly and not stuffy.

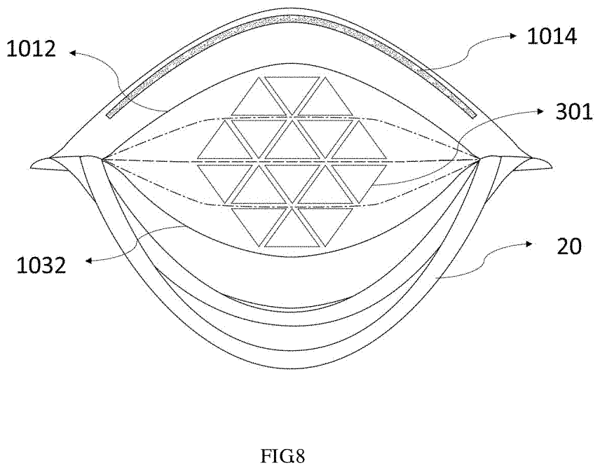

FIG. 8 is a view of the second embodiment of the mask (100) of the present invention in the expanded state. In addition to the features of the first embodiment, the accordion-like folding structure of the second layer (102) is shown to be propped up and then expand the mask (100) to form an accommodating space for the mouth and nose. In this embodiment, because the bottom sides (1012, 1032) of the first layer (101) and the third layer (103) is convex outwards and marked with a solid line. In order to fully describe the characteristics of the accordion-like folding structure, the dashed line in the FIG. 8 is a mountain-shaped folding line; the dotted chain line is a valley-shaped folding line, and the triangle pattern (301) The position of the triangle patterns can stabilize the accordion-like folding structure, maintain the smoothness of breathing, and is not easy to collapse. In addition, the deformable material line (1014) is arranged on the first layer (101) can be more suitable for habit of users.

### Third Embodiment

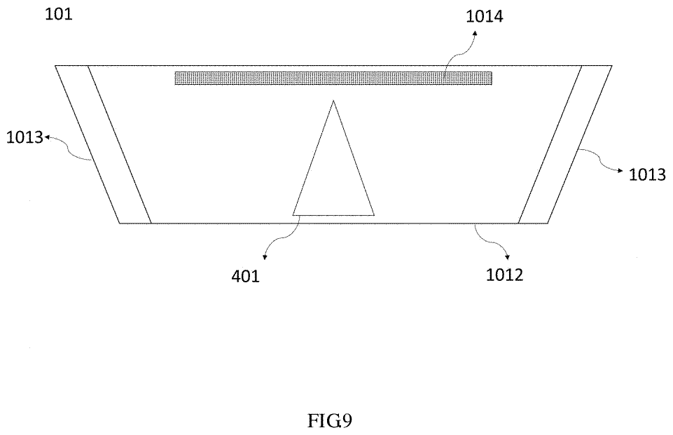

FIG. 9 is a top view of the third embodiment of the mask (100) of the present invention in the folded state, which is the same as the first embodiment, is an isosceles ladder in the folded state, having an upper side (1011), a bottom side (1012) and two short sides (1013), wherein the upper side (1011) and the bottom side (1012) are parallel to each other. The difference is a there is another triangle pattern (401) below a deformable material line (1014). Another triangle pattern (401) can correspond to the nose bridge and both sides of the user when in use. It can also achieve the support function. Generally speaking, it can be used the bridge of the nose as the first supporting part that supports the accommodating space of the mask (100). Another triangular pattern (401) can assist the nose bridge and its both sides so that the first layer (101) will not adhesive to the face when used for a long time, and then causing discomfort for user.

The first layer (101) and the third layer (103) of the mask (100) structure of the present invention and appear the isosceles ladder shape in the folded state in order to respond to the tightness and/or comfort worn by the user. These factors can also be adjusted for the upper side, bottom side, and/or two short sides so that both of them do not present in a straight line. For example, they are curved, lace, zigzag, concave, protruding, or adding a dome shape structure and so on. These variants should be regarded as tantamount to the spirit and scope of the invention.

### Fourth Embodiment

The mask of the present invention can not only achieve the appearance of the mentioned embodiments but the two short sides can be changed to make the mask not be limited to the head-wearing mode for using. By adjusting the number of two short sides of the first layer and the third layer or changing the shape of the first layer and the third layer. Whichever method used; the mask can be changed to the pattern of every user that often used.

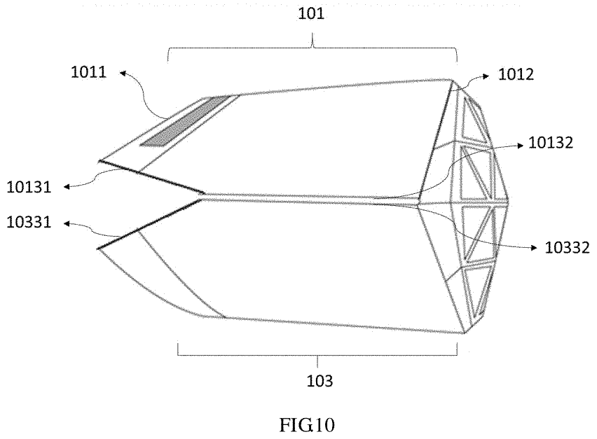

FIG. 10 is a perspective view of a fourth embodiment of a mask. The first layer (101) of the mask has an upper side (1011), a bottom side (1012), and two short sides (1013), The two short sides (1013) are further divided into a first short side (10131) and a second short side (10132). The two short sides (1033) of the third layer are also divided into the first short side (10331) and the second short side (10332), wherein the second short side (10132) of the first layer (101) and the second short side (10332) of the third layer (103) are joined to each other. In the expanded state, the first short side (10131) of the first layer (101) and the first short side (10331) of the third layer (103) can adjust the opening size of the two short sides according to the facial features of the user, this can prevent squeeze the user's face excessively when wearing the mask, and also keep the stability of the accordion-like folding structure of the second layer (102).

In order to enable the person ordinarily skilled in the technical field of this invention to understand the methods of making and using this technique, this invention has been described and exemplified in sufficient detail. However, various variations, modifications or improvements Should be regarded as tantamount to the spirit and scope of the invention.

The term “polygon” is used herein to include triangles, quadrilaterals, pentagons, hexagons, or other closed shapes with a total number of sides greater than or equal to 4, including regular polygons, convex polygons, concave polygons, inscribed polygons, circumscribed polygons, or double-centered polygons.

The purpose of the present invention is easily understood and realized by a person ordinarily skill in the field of technology and the results and advantages mentioned above are obtained. The samples and the processes and methods used to produce the samples represent best embodiments and are in the nature of examples and are not intended to limit the scope of the invention. The persons skilled in the field and the modifications or other uses resulting from the making or use of the art are covered in the spirit of the invention and are limited by the scope of rights.

What is claimed is:

1. A mask comprising:
A first layer in the shape of polygon includes an upper side, a bottom side and at least two short sides;
A third layer in the shape of polygon includes an upper side and a bottom side and at least two short sides. The angle is formed by the bottom side of the first layer and any one of two short sides which is the same as the angle by the bottom side of the third layer and any one of two short sides; and
A second layer has an accordion-like folding structure, wherein the accordion-like folding structure is composed of alternate mountain-shaped folding lines and valley-shaped folding lines, the mountain-shaped folding lines and the valley-shaped folding lines are parallel to the upper side and the bottom side of the first layer and the third layer, the upper and the bottom sides of the accordion-like folding structure are respectively joined to the bottom side of the first layer and the third layer, the left and right sides of the accordion-like folding structure are respectively sandwiched between at least two short sides of the first layer and the third layer, and the second layer is sandwiched between the first layer and the third layer when the mask is stored, and location of the second layer is close to the bottom of the first layer and the third layer, wherein the first layer, the second layer and the third layer form a closed bag with an opening on the upper side, and when the opening is opened, accordion-like folding structure of the second layer is propped up and expanded inside the mask to form a space for the mouth and nose. The upper side of the first layer is in contact with the base of the nose and the zygomatic part of the user and the upper side of the third layer is in contact with the user's jaw when wearing the mask.

2. The mask of claim 1, wherein the accordion-like folding structure comprising odd number of folding lines.

3. The mask of claim 2, wherein the accordion-like folding structure from top to bottom consists of 5, 7 or 9 folding lines which includes the bottom sides of the first layer and the third layer.

4. The mask of claim 3, wherein the accordion-like folding structure from top to bottom consists of 5 folding lines which includes the bottom sides of the first layer and the third layer.

5. The mask of claim 1, wherein the mountain-shaped folding lines and the valley-shaped folding lines in the accordion-like folding structure are isometric arrangement.

6. The mask of claim 1, wherein the mountain-shaped folding lines and the valley-shaped folding lines in the accordion-like folding structure are isometric arrangement.

7. The mask of claim 1, wherein the interval width of adjacent the mountain line and the valley-shape folding line is 0.5 to 6 cm.

8. The mask of claim 1, wherein the angle is from 90° to 140°.

9. The mask of claim 1, wherein the angle is 115°.

10. The mask of claim 1, further comprising a first deformable material line, wherein the first deformable material line locates on the first layer and it is adjacent to the upper side of the first layer which configured to increase the fitness between the mask and the base of the nose and the zygomatic area of the user when wearing the mask.

11. The mask of claim 7, further comprising a second deformable material line, wherein the second deformable material line locates on the third layer and it is adjacent to the upper side of the third layer which configured to increase the fitness between the mask and the user's jaw when wearing the mask.

12. The mask of claim 1, further comprising a second deformable material line, wherein the second deformable material line locates on the third layer and it is adjacent to the upper side of the third layer which configured to increase the fitness between the mask and the user's jaw when wearing the mask.

13. The mask of claim 1, wherein the first layer, the third layer and the second layer are folded by the same piece of material.

14. The mask of claim 1, further comprising at least one fixed strip engaged to two sides of the mask and configured to fix the mask when wearing the mask.

15. The mask of claim 1, wherein the polygon is closed pattern and the total sides of the polygon of the first layer or the polygon of the third layer is greater or equal to 4.

16. The mask of claim 15, wherein the closed pattern comprises at least two equal length sides.

17. The mask of claim 1, further comprising plurality and adjacent triangle patterns between the mountain-shaped folding line and the valley-shaped folding line, each of them is opposite to each other.

18. The mask of claim 17, wherein the any side of each of the triangle pattern is parallel to the mountain-shaped folding line or the valley-shaped folding line.

19. The mask of claim 1, further comprising another triangle pattern on the first layer, the two sides of which correspond to the two sides of the bridge of the nose supplemented with the function of providing the mask support.
